(19) United States
(12) Patent Application Publication
(10) Pub. No.: US 2009/0176137 A1
(43) Pub. Date: Jul. 9, 2009

(54) FUEL CELL SYSTEM

(75) Inventor: Matthias Boltze, Wulkenzin(OT Neuendorf) (DE)

Correspondence Address: DICKINSON WRIGHT PLLC, 1875 Eye Street, NW, Suite 1200, WASHINGTON, DC, 20006, US

(73) Assignee: ENERDAY GMBH, Stockdorf (DE)

(21) Appl. No.: 12/302,363

(22) PCT Filed: Sep. 28, 2006
(86) PCT No.: PCT/DE2006/001720

§ 371 Date: Mar. 3, 2009

(30) Foreign Application Priority Data
Jun. 28, 2006 (DE) 10 2006 029 743.1

(51) Int. Cl. H01M 8/04

(52) U.S. Cl. 429/22; 429/26

(57) ABSTRACT

The invention relates to a fuel cell system comprising a fuel cell (26) for the supply of a hydrogen-rich gas at the anode end and an oxidant at the cathode end for reaction in the fuel cell (26) into an anode exhaust gas and cathode exhaust gas; an afterburner (36) for supply of the anode exhaust gas; and a heat exchanger (46) for the supply of the afterburner exhaust gas, and by means of which the oxidant for supply to the cathode end of the fuel cell (26) is preheatable. In accordance with the invention it is provided for that the supply of the cathode exhaust gas is possible via a cathode exhaust gas line (44) to the heat exchanger (46) downstream of the afterburner (36). The invention relates furthermore to a motor vehicle comprising such a fuel cell system.

The invention relates to a fuel cell system comprising a fuel cell for the supply of a hydrogen-rich gas at the anode end and an oxidant at the cathode end for reaction in the fuel cell into an anode exhaust gas and cathode exhaust gas; an afterburner receiving the supply of the anode exhaust gas; and a heat exchanger receiving the supply of the afterburner exhaust gas, and by means of which the oxidant for supply to the cathode end of the fuel cell is preheatable.

The invention relates furthermore to a motor vehicle comprising one such fuel cell system.

Fuel cell systems serve to convert chemical energy into electrical energy. The element central to such systems is a fuel cell which liberates electrical energy by the controlled reaction of hydrogen and oxygen. Since in a fuel cell or fuel cell stack hydrogen and oxygen are reacted, the fuel used must be conditioned so that the gas supplied to the anode of the fuel cell has as high a percentage of hydrogen as possible, this being the task of the reformer. The hydrogen-rich gas supplied to the anode end of the fuel cell is discharged at the anode end output as an anode exhaust gas, analogously the oxidant supplied to the cathode end being discharged at the cathode end output as the cathode exhaust gas. For combustion of the anode exhaust gas of the fuel cell fuel cell systems generally make use of an afterburner either comprising a native air supply or utilizing the cathode exhaust gas of the fuel cell. This latter principle has the advantage that the thermal energy existing in the cathode exhaust gas is generally recuperated via a heat exchanger located downstream of the afterburner, thus eliminating the need of an additional recuperator in the cathode exhaust gas line. One such fuel cell system is disclosed, for example, in DE 101 42 578 A1. However, the drawback in this prior art is that closed loop control of the afterburner in making use of the cathode exhaust gas for combustion of the anode exhaust gas is difficult to achieve, or indeed unachievable, since the assignment of cathode exhaust gas flow to the anode exhaust gas flow is fixed.

It is thus the object of the present invention to sophisticate the generic fuel cell system such that a better control of the afterburner is now achievable whilst simultaneously making use of the thermal energy of the cathode exhaust gas.

This object is achieved by the features of claim 1.

Advantageous aspects and further embodiments of the invention read from the dependent claims.

The fuel cell system in accordance with the invention is based on generic prior art in that the supply of the cathode exhaust gas is possible via a cathode exhaust gas line to the heat exchanger downstream of the afterburner. This now achieves good open or closed loop control of the afterburner with simultaneous recuperation of the thermal energy from the anode exhaust gas and cathode exhaust gas with just a single heat exchanger. The thermal energy of the anode exhaust gas remains in the exhaust gas leaving the afterburner and is made use of in the heat exchanger downstream of the afterburner to preheat the cathode feed air. By bypassing the afterburner with the cathode exhaust gas it is now possible to supply the afterburner separately with oxidant and despite this, still make use of the thermal energy of the cathode exhaust gas for preheating the cathode feed air. By this possibility of a separate supply of the afterburner with oxidant the coupling of cathode feed air and cathode exhaust gas is now disrupted to advantage. A further advantage of this configuration is that in making use of the thermal energy of the anode and cathode exhaust gas the afterburner is now relieved of thermal stress.

In addition, the fuel cell system in accordance with the invention can be further sophisticated so that a valve is provided with which the cathode exhaust gas between the fuel cell and heat exchanger can now be branched off fully or in part in thus achieving the advantage of faster starting. If on starting the system the cathode exhaust gas were to be fully supplied to the heat exchanger, it would take longer until the cathode feed air has been sufficiently preheated. This is why with such a valve the supply of the cathode exhaust gas to the heat exchanger can now be controlled, meaning in practice that little or no cathode exhaust gas is supplied to the heat exchanger in the starting phase of the fuel cell system, but only hot afterburner exhaust gas instead. After the starting phase, when the cathode exhaust gas is hot enough, the cathode exhaust gas can be supplied fully to the heat exchanger.

Furthermore, this further embodiment may be configured so that the valve is sited outside of an insulation thermally insulating at least the fuel cell, the afterburner and the heat exchanger from the environment. This configuration has the advantage that the valve is now relieved of thermal stress by it being located outside of the insulation, so that standard valves (EGR) can now be used.

In addition, the fuel cell system in accordance with the invention can be configured such that a temperature sensor is provided in the cathode exhaust gas line upstream of the heat exchanger. This temperature sensor now makes it possible to control the input temperature of the anode exhaust gas streaming into the heat exchanger by the change in the relationship of afterburner anode exhaust gas to cathode exhaust gas. Furthermore, the sensed temperature serves as a variable for commanding open loop control of the valve in the cathode exhaust gas bypass line.

In addition it may be provided for that the cathode exhaust gas line is structured as a shroud surrounding the afterburner, resulting in a relief in thermal stress of the afterburner, since by configuring the cathode exhaust gas line surrounding the afterburner in the form of a shroud it serves as a jacket for cooling the afterburner whilst the heat exhausted by the afterburner can be supplied to the heat exchanger for preheating the cathode feed air, as a result of which the afterburner now needs to furnish less thermal energy in thus enabling the afterburner to be well cooled despite the thermal energy remaining in the fuel cell system.

Furthermore the fuel cell system in accordance with the invention may be configured so that in an oxidant feed line for supplying oxidant to the afterburner a separately controllable delivery means is now provided, by means of which the supply of oxidant can be controlled irrespective of the cathode air feed, in thus achieving good open and closed loop control of the afterburner.

With the motor vehicle in accordance with the invention incorporating such a fuel cell system the advantages as recited above are achieved correspondingly in the motor vehicle.

A preferred embodiment of the invention will now be detailed with reference to the attached drawings by way of example, in which:

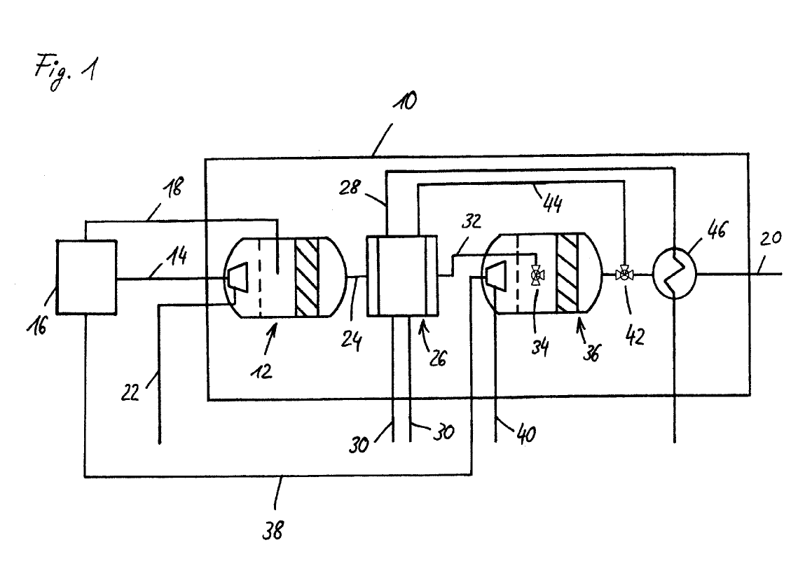

FIG. 1 is a diagrammatic representation of a fuel cell system in accordance with a first example embodiment; and

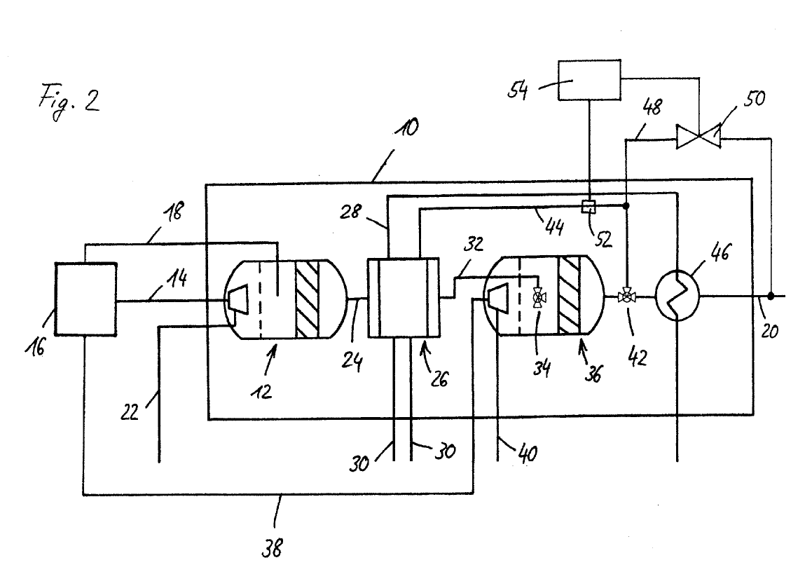

FIG. 2 is a diagrammatic representation of a fuel cell system in accordance with a second example embodiment.

Referring now to FIG. 1 there is illustrated a diagrammatic representation of a fuel cell system in accordance with a first example embodiment. The fuel cell system installed in a motor vehicle comprises a reformer 12 which receives a supply of fuel via a first fuel line 14 from the fuel tank 16, fuel also being supplied to the reformer 12 by means of a second fuel line 18. This fuel may be diesel, gasoline, biogas or any other type of fuel known in prior art. Furthermore, the reformer 12 receives a supply of oxidant, for example air, via a first oxidant line 22. The reformate generated by the reformer 12 is supplied via a reformate line 24 to a fuel cell stack 26. As an alternative to the fuel cell stack 26 just a single fuel cell may be provided. The reformate concerned is a hydrogen-rich gas which is reacted in the fuel cell stack 26 with the aid of cathode feed air (an oxidant) furnished via a cathode feed air line 28 in generating electricity and heat. The electricity generated can be picked off via electric terminals 30. In the case as shown, the anode exhaust gas is supplied via an anode exhaust gas line 32 to a mixer 34 of an afterburner 36. The afterburner 36 receives a supply of fuel from the fuel tank 16 via a third fuel line 38. Furthermore the afterburner 36 receives a supply of oxidant via a second oxidant line 40. Provided in the fuel lines 14, 18 and 38, in the oxidant lines 22 and 40 as well as in the cathode feed air line 28 are corresponding delivery means such as, for example, pumps or blowers and/or control valves for closed loop control of the flow. In this arrangement, closed loop control of the delivery means assigned to the second oxidant line 40 is separate from that of the delivery means assigned the first oxidant line 22. In the afterburner 36 the depleted anode exhaust gas is reacted with the supply of fuel and oxidant into a combustion exhaust gas which is mixed with the cathode exhaust gas in a mixer 42 furnished via a cathode exhaust gas line 44 from the fuel cell stack 26 to the mixer 42. The combustion exhaust gas, which contains near zero noxious emissions, streams through the heat exchanger 46 to heat the cathode feed air before finally leaving the fuel cell system via an exhaust gas outlet 20. The portion of the line between the mixer 42 and the heat exchanger 46 is simultaneously a portion of the cathode exhaust gas line as well as a portion of the afterburner exhaust gas line. The fuel cell system, particularly the reformer 12, fuel cell stack 26, afterburner 36 and heat exchanger 46 are surrounded by a thermal insulation 10 which thermally insulates these components from the environment. Provided furthermore is a controller (not shown) for activating and closed loop control of the delivery means provided in the fuel and oxidant supply lines 14, 18, 22 38 and 40.

Referring now to FIG. 2 there is illustrated a diagrammatic representation of a fuel cell system in accordance with a second example embodiment. To avoid tedious repetition only the differences as compared to the first embodiment are discussed in the following. One effect of the admixture of cathode exhaust gas as discussed in the further example embodiment via the mixer 42 is a probable delay in starting the system because of the cathode exhaust gas still being cold on starting, i.e. not being hot enough to sufficiently preheat the cathode feed air via the heat exchanger 46. This is why in an advantageous further development in the second embodiment a cathode exhaust gas bypass line 48 is branched off from the cathode exhaust gas line 44 between the fuel cell stack 26 and mixer 42 to port into the exhaust gas outlet 20 at the other end downstream of the heat exchanger 46. The cathode exhaust gas bypass line 48 is provided with a valve 50 as a kind of throttle valve with which the flow of cathode exhaust gas supplied to the mixer 42 can be controlled. Also disposed upstream of the heat exchanger 46 is a temperature sensor 52, more accurately upstream of the branch-off of the cathode exhaust gas bypass line 48 in the cathode exhaust gas line 44 for controlling the temperature of the cathode exhaust gas. As an alternative the temperature sensor 52 can be disposed between the mixer 42 and the heat exchanger 46 to sense the inlet temperature of the anode exhaust gas leading to the heat exchanger 46. By evaluating this temperature sensor an electronic controller 54 is able to correspondingly activate the valve 50. On system start the valve 50 is opened sufficiently so that most of the cathode exhaust gas bypasses the heat exchanger 46 via the cathode exhaust gas bypass line 48, resulting in the heat exchanger 46 receiving only or mainly afterburner exhaust gas at a high temperature for a fast system start, i.e. fast preheating of the cathode feed air in the cathode feed air line 28. Once the system has attained a certain operating temperature, so that also the temperature of the cathode exhaust gas increases, the valve 50 is closed all the more continually, so that more cathode exhaust gas is supplied to the mixer 42 and thus the heat exchanger 46, resulting in the recuperation effect being achieved. When the valve 50 is controlled in this way, the temperature sensed by the temperature sensor 52 serves as the command variable. To relieve the thermal stress the valve 50 is preferably arranged outside of the thermal insulation 10 in thus making it possible to employ standard components like EGR valves as known from automotive exhaust systems. Structurally the cathode exhaust gas line 44 is preferably configured shrouding the afterburner 36. For example, the cathode exhaust gas line 44 may be configured as a spiral tube surrounding the afterburner 36. As an alternative the cathode exhaust gas line 44 may shroud the afterburner 36 as a double shell sleeve through the interspace of which the cathode exhaust gas streams.

In a further version the cathode exhaust gas line 44 may be provided with a controllable delivery means by means of which closed loop control of the cathode exhaust gas flow is possible.

It is understood that the features of the invention as disclosed in the above description, in the drawings and as claimed may be essential to achieving the invention both by themselves or in any combination.

### LIST OF REFERENCE NUMERALS

10 thermal insulation
12 reformer
14 first fuel line
16 fuel tank
18 second fuel line
20 exhaust gas outlet
22 first oxidant line
24 reformate line
26 fuel cell stack
28 cathode feed air line
30 electric terminals
32 anode exhaust gas line
34 mixer
36 afterburner
38 third fuel line
40 second oxidant line
42 mixer
44 cathode exhaust gas line
46 heat exchanger
48 cathode exhaust gas bypass line
50 valve
52 temperature sensor
54 electronic controller

1. A fuel cell system comprising
a fuel cell receiving the supply of a hydrogen-rich gas at the anode end and an oxidant at the cathode end for reaction in the fuel cell into an anode exhaust gas and cathode exhaust gas;
an afterburner receiving the supply of the anode exhaust gas; and
a heat exchanger receiving the supply of the afterburner exhaust gas, and by means of which the oxidant for supply to the cathode end of the fuel cell is preheatable,
characterized in that the supply of the cathode exhaust gas is possible via a cathode exhaust gas line to the heat exchanger downstream of the afterburner.

2. The fuel cell system of claim 1, characterized in that a valve is provided with which the cathode exhaust gas between the fuel cell and heat exchanger can be branched off fully or in part.

3. The fuel cell system of claim 2, characterized in that the valve is sited outside of an insulation thermally insulating at least the fuel cell, the afterburner and the heat exchanger from the environment.

4. The fuel cell system of claim 1, characterized in that a temperature sensor is provided in the cathode exhaust gas line upstream of the heat exchanger.

5. The fuel cell system of claim 1, characterized in that the cathode exhaust gas line is structured as a shroud surrounding the afterburner.

6. The fuel cell system of claim 1, characterized in that in an oxidant feed line for supplying oxidant to the afterburner a separately controllable delivery means is provided.

7. A motor vehicle comprising a fuel cell system of claim 1.
